(19) United States
(12) Patent Application Publication
(10) Pub. No.: US 2004/0064404 A1
(43) Pub. Date: Apr. 1, 2004

(54) Computer-based method for automatic remote coding of debtor credit databases with bankruptcy filing information

(76) Inventors: Menachem Cohen, Ramat Gan (IL); Wadih Amin Pazos, Miami, FL (US); Lola Patricia Valladares-Foo, Pembroke Pines, FL (US)

Correspondence Address: LOTT & FRIEDLAND, P.A., P.O. BOX 141098, CORAL GABLES, FL, 33114-1098, US

(21) Appl. No.: 10/262,254

(22) Filed: Oct. 1, 2002

(51) Int. Cl. G06F 17/60

(52) U.S. Cl. 705/38

(57) ABSTRACT

Disclosed is a computer-implemented method for automatic remote coding of a debtor credit card account database with bankruptcy filing information comprising, at a local data processing location, the steps of collecting bankruptcy filing reports from courts located within the various jurisdictions for which the method provides coverage, extracting unique debtor identifying data from the bankruptcy filing reports, and generating a database query designed to identify database records which match the unique debtor identifying data; the step of establishing an electronic connection between the local data processing location and a remote credit database storage location, the electronic connection being suitable for two-way transmission of data between the local data processing location and the remote credit database storage location; the step of executing, from the local data processing location, the database query against a debtor credit database housed at the remote credit database storage location and identifying debtor records matching the database query; and the step of coding the matching records at the debtor credit database with bankruptcy filing information.

### FIELD OF INVENTION

The present invention relates generally to methods for remotely searching for, locating and updating selected records from a remotely located database and the present invention specifically relates to a method of remotely coding records in debtor credit card account databases with information regarding bankruptcy filings.

### BACKGROUND OF THE INVENTION

The consumer credit card industry has enjoyed explosive growth in the past decade. The tremendous growth in the industry has required credit card providers, and third-party administrators of those accounts, to computerize their account processing and handling activities as much as possible. One aspect of processing and handling of credit card accounts which is particularly automated is billing, and, particularly as it relates to the present invention, collection activities directed at holders of delinquent accounts.

In order to maintain proper controls over the status of consumer accounts, credit card issuers (hereinafter “Issuers”) have developed specialized computer applications which analyze critical information concerning credit card accounts and initiate particular collection-related activities when certain thresholds have been met. For instance, an initial “past due” letter may be sent to the holder of a credit card (hereinafter “Holder”) once payment has not been received for a certain number of days after the payment due date. More stringent measures, such as the referral of an account to the Issuer's collections department, a collection agency, or to an outside attorney, may follow if the number of days the account is past due exceeds a second or subsequent threshold.

The success rate of an Issuer's automated collection efforts depends on the accuracy and completeness of the financial data it maintains for each of the accounts it services. For this reason, Issuers place tremendous reliance on large and sophisticated account databases which are updated millions of times each day to ensure their accuracy and completeness.

The account databases maintained by Issuers contain information about each credit card account and Holder which is critical for the correct processing of payments and for the commencement, tracking, and termination of collections activities. For example, the credit card account databases contain basic contact information about each account, the balance due for each account, and the date or dates when payments are supposed to be made by the credit card holder. Another piece of information which is usually maintained by an Issuer in its database of accounts is the bankruptcy status of the account's Holder. The electronic manipulation of this bankruptcy status information is the central focus of the present invention.

Issuers place great emphasis on the maintenance of accurate information about the bankruptcy status of Holders because federal laws in the United States require them to not commence collections activities against any Holder who files for bankruptcy relief. The same laws require any activity related to the collection of a debt to be immediately suspended or “stayed” by the Issuer once it receives notice that the Holder has filed for bankruptcy. The penalties to which the Issuer is subject for failing to cease collection activities once it receives formal notice of a bankruptcy filing, or for commencing collections-related activity against a bankruptcy filer, can be severe.

In addition, in order to preserve certain rights to collect, at least partially, monies due to it by a bankrupt Holder, an Issuer must, shortly after learning about the bankruptcy filing, or upon notice received, assert the debt to the appropriate bankruptcy court by filing a “proof of claim”. Failure to file a timely proof of claim may cause the Issuer to forfeit any claim it may have to bankruptcy proceeds despite the existence of a valid debt and funds available to satisfy same. Other remedies which are also time-sensitive may be available to the Issuer as well.

The problem faced by Issuers, particularly the larger entities, is that they have accounts which number in the hundreds of millions. As a consequence, they are named as creditors in hundreds of thousands of bankruptcy filings every day. Issuers are typically notified of the bankruptcy filing by one of their Holders, through a paper form issued by the court where the Holder files for bankruptcy. An electronic notice may also be received under certain circumstances. The paper forms allow the Issuer, upon receipt, to: (a) extract the relevant information from the form; (b) locate accounts held by the Holder named in the form from among the millions of accounts serviced by the Issuer; (c) verify that the located Holder account or accounts are the correct ones; and (d) annotate the database with the bankruptcy information. This, in turn, ensures that activity on annotated accounts may be commenced or halted as necessary to be compliant with federal bankruptcy and banking laws. Because the paper forms are not always uniform from court to court, Issuer currently must perform these functions manually, which task carries with it a tremendous cost in manpower and resources and with reduced accuracy.

A review of prior efforts reveals that a computer-based method for automatic remote coding of debtor credit databases with bankruptcy filing information has never been realized. Previous attempts at automated methods relating to the coding of financial databases are described in U.S. Pat. No. 4,914,587 to Clouse, (the '587 patent); U.S. Pat. No. 5,274,547 to Zoffel, (the '547 patent); U.S. Pat. No. 6,098,052 to Kosiba et al., (the '052 patent); U.S. Pat. No. 5,323,315 to Highbloom, (the '315 patent); U.S. Pat. No. 5,615,408 to Johnson et al. (the '408 patent); U.S. Pat. No. 6,119,103 to Basch et al., (the '103 patent); and U.S. Pat. No. 5,426,281 to Abecassis, (the '281 patent), each of which is incorporated here by reference.

The '587 patent describes a financial data processing system utilizing two levels of distributed processors interconnected to one another and a central processor interconnected to the first level of distributed processors. The financial data being processed includes loan information representing the balance of each loan outstanding, the interest rate payable on each loan, the principal and interest due and payable for each periodic loan payment, the identity of each debtor, the delinquency, if any, on each loan, the collection histories of respective loans and financial information relating to leases and leased property. In one embodiment, the system provides for the high speed entry of data utilizing optical character readers which are utilized to scan customer statements containing pre-printed financial data in a format and type recognizable by the optical character reader.

The '547 patent describes a system and method for automatically generating credit reports. The system includes a central data processing facility which is connectable to national credit repositories through dedicated data links. The central data processor requests credit information on an applicant from one or more of the repositories, generates a credit report, and transmits the report to the requesting user (i.e., customer). Requests and reports are transmitted via a communications system or network. If data is inputted from more than one repository, the central data processing facility eliminates duplicated data, selects the best data if there are conflicts, and merges the remaining data into a single report.

The '052 patent describes a computerized collection strategy model for use in collecting payments from delinquent accounts. The computerized collection strategy model estimates for each possible collection strategy, how much will be paid on each account in response to that collection strategy, estimates the amount of resources to be expended in the execution of that collection strategy, and recommends a particular collection strategy for each account that optimizes the use of the available collection resources.

The '315 patent describes a system for monitoring the status of individual items of personal property which serve as collateral for securing financing. The system receives financing information from a first financing source and a second financing source. A unique identification code is associated with each individual item of personal property which serves as collateral for securing financing from the first and second financing sources. The financing information from the first financing source is compared with the financing information from the second financing source based at least in part upon the identification codes of the items of personal property to identify particular items of personal property that simultaneously serve as collateral to secure financing from both the first and second financing sources. The affected first and second financing sources are notified about the identified item of personal property.

The '408 patent describes an apparatus for credit based management of a telecommunication system. One embodiment of the apparatus includes an interface for communicating credit information on a particular subscriber and for receiving call records for the particular subscriber that are derived from a switch which establishes connections between telecommunication devices. A credit limit device then utilizes the credit information to establish a credit limit for the subscriber. The apparatus also includes a device for comparing the particular subscriber's call usage to a credit limit established for the subscriber based on information obtained from the credit bureau. An output device is used to provide an indication that the subscriber has exceeded their credit limit. Another embodiment of the apparatus, includes a device for, upon expiration of a predetermined time period, contacting the credit bureau to obtain a new credit score for a subscriber and use this score to update the subscriber's credit limit.

The '103 patent describes a computer-implemented method for predicting financial risk, which includes receiving first transaction data pertaining to transactions performed on a first financial account. The first financial account represents a financial account issued to a given account holder by a first account issuer. The method further includes receiving second transaction data pertaining to transaction performed on a second financial account different from the first financial account. The second financial account represents a financial account issued to the given account holder by a second account issuer different from the first account issuer. There is further included scoring the first transaction data and the second transaction data based on a preexisting model to form a score for the account holder. Additionally, there is included transmitting, if the score is below a predefined financial risk threshold, the score to one of the first account issuer and the second account issuer.

The '281 patent describes a transaction protection system that permits non-related third parties to offer an impartial, readily accessible standardized service that will protect and encompass any moneys that are tendered by an individual or business entity to a transaction in relation to a second business or entity. Delivery of payment will occur upon a future condition being met automatically whereby the system both performs an escrowing function, a payment function and a notifying function automatically. The transaction processing system acts as a temporary depository control in the flow of the moneys from parties in a transaction ensuring that sufficient balances are available for the transaction and assuring that payment is made only upon satisfaction of the conditions set by the parties to the transaction. The system is implemented by means of either an integrated credit/debit system, deposit slips and forms or through conventional checks combined with either credit card or deposit slips. The system may be implemented using site dependent or site independent (portable) point of sales terminals, computers or touch tone telephones. The system further implements electronic accessing means for allowing either of the parties to the transaction to affect the processing of the transaction.

None of the inventions described in the prior art include a computer-based method for coding of databases which automatically extracts bankruptcy filing information received in a variety of formats and seamlessly interacts with a remote credit card account database to update individual account records therein with said bankruptcy information to help ensure adequate compliance with applicable debt collection laws.

Accordingly, there is a need in the prior art for a computer-based method for coding of debtor credit card account databases with bankruptcy filing information which significantly automates the process of extracting data from paper-based or electronic notices regarding the filing of new bankruptcies or changes in the status of existing bankruptcies.

There is a further need in the prior art for a computer-based method for coding of debtor credit databases with bankruptcy filing information which facilitates and automates the coding of remote credit databases through the use of a widespread computer network.

There is a further need in the prior art for a computer-based method for coding of debtor credit databases with bankruptcy filing information which can interact remotely, with minimal adaptation, with different types of credit databases regardless of the database vendor, the computer language used to program and access the database, the database configuration, or the access rules governing the database.

There is yet a further need in the prior art for a computer-based method for coding of debtor credit databases with bankruptcy filing information which can automatically generate comprehensive reports detailing all changes made to said databases.

### SUMMARY OF THE INVENTION

The present invention overcomes significant deficiencies in the prior art by providing a computer-implemented method for automatic remote coding of a debtor credit card account database with bankruptcy filing information comprising, at a local data processing location, the steps of collecting bankruptcy filing reports from courts located within the various jurisdictions for which the method provides coverage, extracting unique debtor identifying data from the bankruptcy filing reports, and generating a database query designed to identify database records which match the unique debtor identifying data; the step of establishing an electronic connection between the local data processing location and a remote credit database storage location, the electronic connection being suitable for two-way transmission of data between the local data processing location and the remote credit database storage location; the step of executing, from the local data processing location, the database query against a debtor credit database housed at the remote credit database storage location and identifying debtor records matching the database query; and the step of coding the matching records at the debtor credit database with bankruptcy filing information.

Accordingly, it is an object of the present invention to provide a computer-based method for coding of debtor credit databases with bankruptcy filing information which significantly automates the process of extracting data from paper-based or electronic notices regarding the filing of new bankruptcies or changes in the status of existing bankruptcies.

It is an additional object of the present invention to provide a computer-based method for coding of debtor credit databases with bankruptcy filing information which facilitates and automates the coding of remote credit databases through the use of a widespread computer network.

It is an additional object of the present invention to provide a computer-based method for coding of debtor credit databases with bankruptcy filing information which can interact remotely, with minimal adaptation, with different types of credit databases regardless of the database vendor, the computer language used to program and access the database, the database configuration, or the access rules governing the database.

It is an additional object of the present invention to provide a computer-based method for coding of debtor credit databases with bankruptcy filing information which can automatically generate comprehensive reports detailing all changes made to said databases.

These and other objects, features, and advantages of the present invention may be more clearly understood and appreciated from a review of ensuing detailed description of the preferred and alternate embodiments and by reference to the accompanying drawings and claims.

### BRIEF DESCRIPTION OF THE DRAWINGS

FIG. 1 is a schematic block diagram which shows the interrelationship between different hardware and software components of the system.

FIG. 2 is a schematic representation of the database structure used in the preferred embodiment of the present invention.

FIGS. 3A-3C are a flowchart illustrating the basic steps in the operation of the present invention.

FIG. 4 is an illustration of a sample blank Notice of Chapter 7 Bankruptcy Case of the type processed by the preferred embodiment of present invention.

FIG. 5 is an illustration of the user interface for the custom data-entry application used in the preferred embodiment of the present invention.

FIG. 6 is an illustration of a sample activity report generated using the preferred embodiment of the present invention.

### DETAILED DESCRIPTION OF THE PREFERRED EMBODIMENT

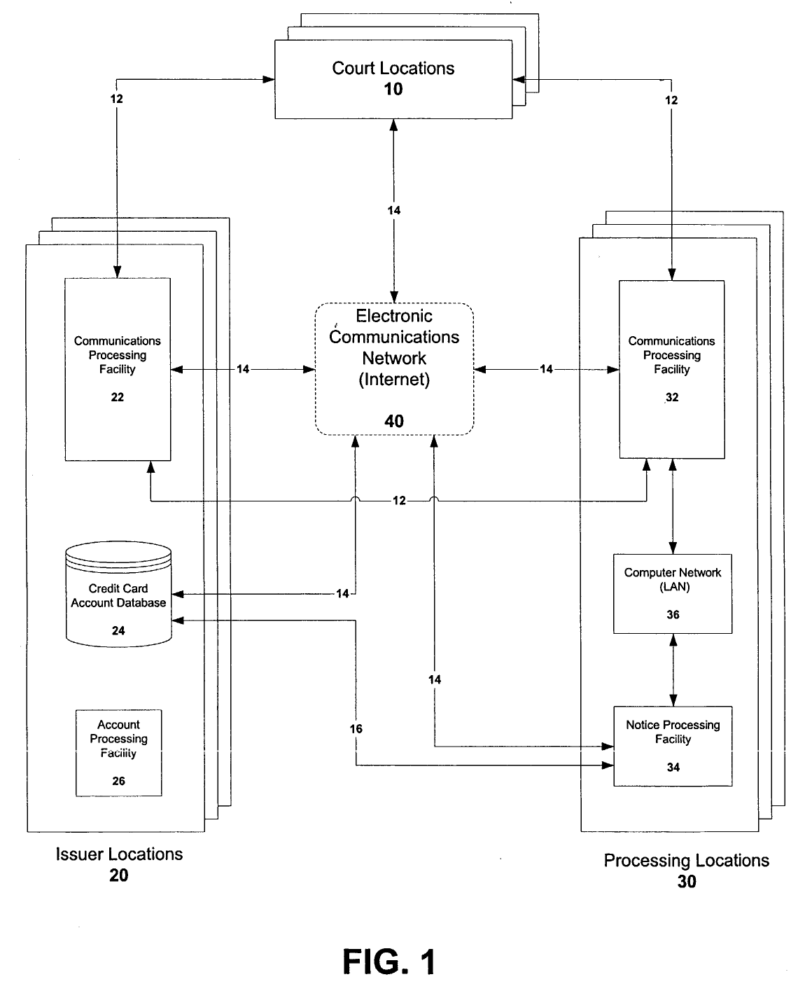

Referring initially to FIG. 1 of the drawings, in which like numerals indicate like elements throughout the several figures, the environment in a preferred embodiment of the present invention includes at least one Court Location 10, at least one Issuer Location 20 and at least one Processing Location 30. It is envisioned at present that each of the three aforementioned locations will be housed in a separate physical building, however, a separate geographic presence for each location is not necessary for the present invention to function. The Court Locations 10 can transmit paper-based communications to the Issuer Locations 20 and the Processing Locations 30 by means of traditional methods such as mail, messenger service, facsimile, telegraph, and the like 12. The Court Locations 10 can transmit electronic-based communications to the Issuer Locations 20 and the Processing Locations 30 by means of an electronic link 14 which is in turn connected to an electronic communications network, such as the Internet 40.

Each Issuer Location 20 is equipped with a communications processing facility 22 which is responsible for receiving communications from the Court Locations 10 and transmitting communications to the Processing Locations 30. The Issuer Location communications processing facility 22 can receive communications from the Court Locations 10 via traditional methods such as mail, messenger service, facsimile, telegraph, and the like 12 or via an electronic link 14 connection to an electronic communications network, such as the Internet 40. Similarly, The Issuer Location communications processing facility 22 can transmit communications to the Processing Location communications processing facility 32 via traditional methods such as mail, messenger service, facsimile, telegraph, and the like 12 or via an electronic link 14 connection to an electronic communications network, such as the Internet 40.

Also housed at the Issuer Location 20 is at least one credit card account database 24 which contains account information, including bankruptcy status information, about credit cards issued by the Issuer. The credit card account database 24 is accessible by electronic means to computers external and internal to the Issuer. An example of a computer having access to the credit card account database 24 is an account processing facility 26 which can be, but need not be, physically housed at the Issuer Location. The account processing facility 26 could, for example, obtain information from the credit card account database for billing purposes or in order to initiate or terminate collection-related activities.

Each Processing Location 30 is equipped with a communications processing facility 32 which is responsible for receiving communications from the Court Locations 10 and from the Issuer Locations 20. The Processor Location communications processing facility 32 can receive communications from the Court Locations 10 and the Issuer Locations 20 via traditional methods such as mail, messenger service, facsimile, telegraph, and the like 12 or via an electronic link 14 connection to an electronic communications network, such as the Internet 40. Similarly, the Processing Location communications processing facility 32 can transmit communications to the Issuer Locations 20 via traditional methods such as mail, messenger service, facsimile, telegraph, and the like 12 or via an electronic link 14 connection to an electronic communications network, such as the Internet 40.

Also housed at the Processing Location 30 is at least one notice processing facility 34 where bankruptcy-related notices received by the Processing Location are processed in order to ultimately generate updates to the credit card account database 24. The notice processing facility 34 is linked electronically to the Processing Location's communications processing facility 32 through a traditional internal network infrastructure such as a Local Area Network (“LAN”) 36. Alternatively, if the notice processing facility 34 is at a location different than the communications processing facility 32, communication between the two locations may be established through a Wide Area Network (“WAN”) or through the Internet 40.

Finally, the notice processing facility 34 is also linked electronically 16 to the credit card account database 24 by means of a WAN, LAN, through the Internet or by any other standard network connection.

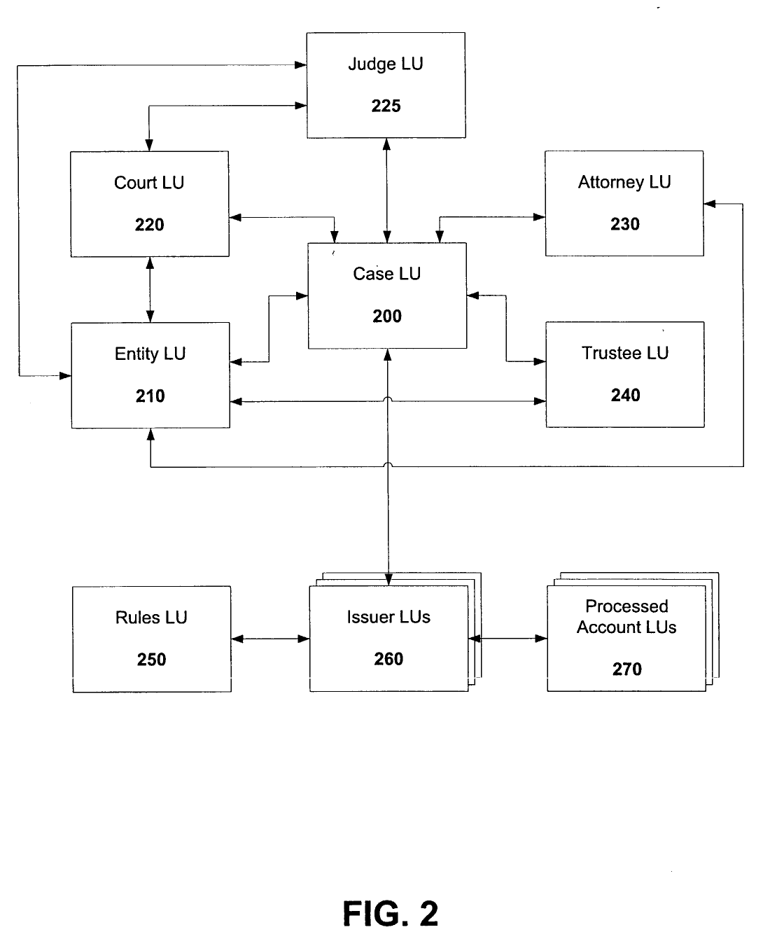

At the heart of the preferred embodiment of the present invention lies an integrated set of database applications residing inside computers located at the notice processing facility 34. These applications receive new bankruptcy-related notices, processes them, remotely link with and update the credit card account databases 24 and generate reports detailing these activities. The general database structure for these applications is described in FIG. 2.

In the preferred embodiment, the database structure is composed of several database constructs which are referred to hereinafter as Logical Units (“LUs”). In abstract terms, an LU is a logical representation of a database or a subset of a database. In the present instance, an LU is a collection of tables and similar database constructs which are related by means of rules defining relationships between the constructs.

Referring now to FIG. 2, the central database LU is called a Case LU 200. The Case LU 200 contains information about each individual bankruptcy-related notice processed by the system. The information contained in the Case LU 200 includes case-specific data such as the court case number, the filing date, the Issuer or issuers affected by the Notice, the type of bankruptcy and the type or types of notices received. The Case LU 200 is linked, or “related”, to several other LUs which contain additional information applicable to the cases stored in the Case LU 200. Additional LUs which are related to the Case LU 200 include: the Entity LU 210, the Court LU 220, the Judge LU 225, the Attorney LU 230, the Trustee LU 240, the Issuer LU 260, and the Processed Account LU 270.

The Entity LU 210 contains data about all individuals, corporations or other legal entities who are Holders of an Issuer's credit card and are identified as debtors in bankruptcy filings where the Issuer is identified as a creditor. The Entity LU 210 contains information such as names, addresses, social security numbers, federal tax identification numbers, telephone numbers, and the like, for each entity.

The Court LU 220 contains data about the different courts from which an Issuer has received information on bankruptcy filings naming the Issuer as a creditor. The Court LU 220 contains information such as the address, names of clerks, telephone numbers, and the like, for each court.

The Judges LU 225 contains data about the different judges presiding over bankruptcy cases for which an Issuer has received information on bankruptcy filings naming the Issuer as a creditor. The Judges LU 220 contains information such as the address, names, telephone numbers, and the like, for each judge.

The Attorney LU 230 contains data about the different attorneys named in bankruptcy filings where the Issuer is identified as a creditor. The Attorney LU 230 contains information such as lawyers names, law firm names, addresses, telephone numbers, and the like, for each attorney.

Each Issuer serviced by the method of the present invention, has a corresponding Issuer LU 260 and Processed Account LU 270. Each Issuer LU and Processed Account LU 270 contains data about its corresponding Issuer.

Each Issuer LU 260 contains information such as addresses, telephone numbers, kinds of credit cards, database locations and access information, and the like, for each Issuer. The Issuer LU 260 also contains information about the Issuer's computer system, its structure, “front-end” applications used to access the credit card account database 24 and handling instructions for particular types of bankruptcy-related notices.

Each Processed Account LU 270 contains data about the different accounts for its corresponding Issuer which have been processed using the method of the present invention. The Processed Account LU 270 contains information such as account numbers, balances, bankruptcy status, types of notices processed, and the like, for each Issuer account processed.

The Case LU 200, the Entity LU 210, the Court LU 220, the Judge LU 225, the Attorney LU 230, the Trustee LU 240, the Issuer LU 260, and the Processed Account LU 270 are all related to form a cohesive repository of data containing all of the relevant information extracted from bankruptcy notices received at the Processing Location 30. Every record in the Entity LU 210, the Court LU 220, the Attorney LU 230, the Trustee LU 240, the Issuer LU 260, and the Processed Account LU 270 is indexed to at least one record in the Case LU 200. Using this relationship between the different LUs, it is possible to quickly and efficiently generate a data structure element which contains all of the information necessary to update the credit card account database 24 with the information contained in a single bankruptcy-related notice. These data structure elements, akin to records in a “virtual” database table, are hereinafter referred to as Software Objects (“SOs”). SOs do not only contain data but also contain routines that manipulate the data within the SO. Routines contained within an SO can, for example, be used to compare two SOs and determine whether their data matches.

For example, a Bankruptcy SO is a collection of all of the known data about a particular bankruptcy case and contains information such as: the court case number, the case's filing date, the bankruptcy filer's identifying data, the court identifying data, the attorney identifying data, the judge identifying data, and the trustee identifying data. This information is obtained from all of the aforementioned LUs and assembled into a virtual record. An SO is said to be a “virtual” record because it is not permanently stored in any particular place but rather, it is formed “on-the-fly” as needed to perform a particular operation.

In addition to a Bankruptcy SO, in the preferred embodiment of the present invention a number of other types of SOs can be created. Possible types of SOs include Entity SOs (including identifying information about an entity that is the subject of a bankruptcy-related notice, i.e. an individual or corporate debtor who lists an Issuer as a creditor); Court SOs, Attorney SOs and Attorney SOs.

By using the above-described structure of related database LUs, the method of the present invention uses a more streamlined and efficient database than would be otherwise possible. For example, if a particular trustee is assigned to more than one bankruptcy filing (a likely scenario) and a “flat” database structure were used (i.e., one not depending on a series of related LUs), the information for the trustee would be duplicated for every record of a filing to which he is assigned. By using related LUs, the trustee's information can be entered only once and then be associated with multiple case records.

In addition to the LUs discussed above, which contain data about specific bankruptcy filing, the database structure of the present invention contains an additional type of LU, the Rules LU 250, which includes information about Comparison Rules (a term which is defined later in this specification) and thresholds necessary to match information contained in bankruptcy-related notices to particular accounts within accounts found in that Issuer's credit card account database 24. The Rules LU 250 also includes rules regarding the level of accuracy which is necessary to establish that a record in the credit card account database matches information contained in a bankruptcy-related filing.

In the preferred embodiment of the present invention, each Issuer will be assigned a record in the Rules LU 250 that defines the Matching Rules (a term which is defined later in this specification) and Comparison Rules and thresholds applicable to that Issuer.

The use of a Rules LU 250, as opposed to “hard coding” the database manipulation rules into a custom application, permits more flexibility in increasing the number of Issuers whose credit card account databases can be annotated by the instant method. To wit, in order to be able to service a new Issuer's credit card account database, essentially, the only specialized code which needs to be written is a record in the Rules LU defining Matching and Comparison Rules and thresholds for that Issuer, and the creation of an Issuer LU 260 with information applicable to that Issuer.

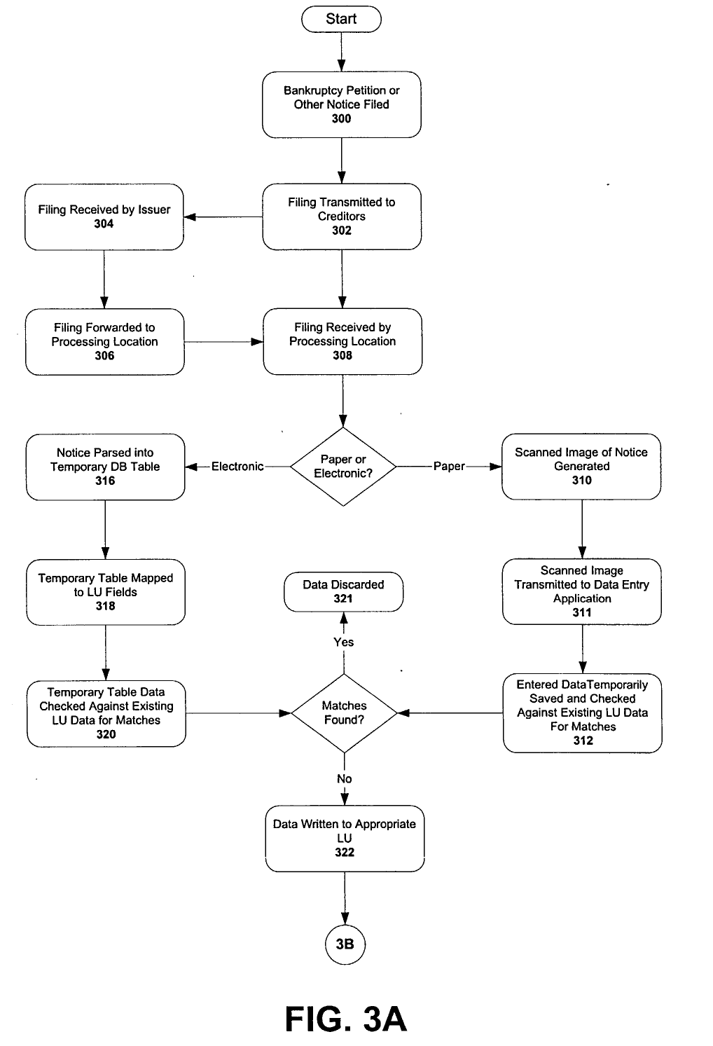

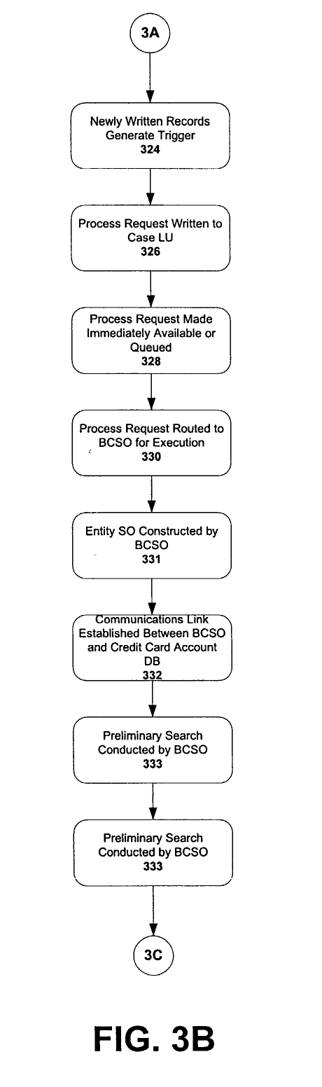

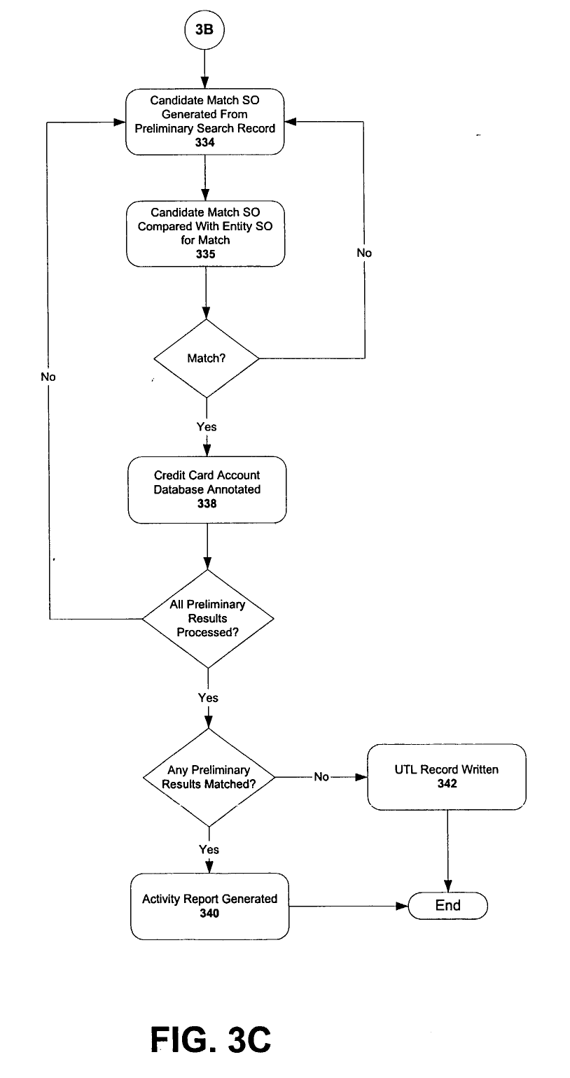

FIGS. 3A-3C generally depict the steps utilized in the present invention to update and annotate an Issuer's credit card account database 24 from the time a bankruptcy related notice is filed.

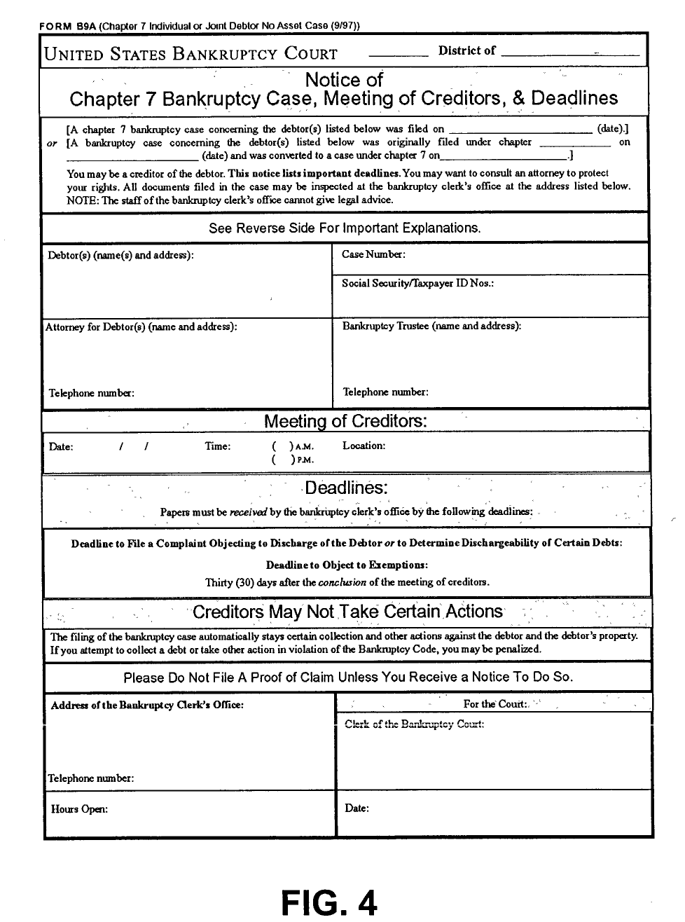

Beginning with FIG. 3A, the process starts with the filing of a bankruptcy petition in bankruptcy court by a debtor who is also a Holder 300. The court upon commencement of a bankruptcy case issues a Notice of Commencement of Bankruptcy under either Chapter 7, Chapter 11, or Chapter 13 of the U.S. Bankruptcy Code (Title 11, United States Code). A sample blank Notice of Chapter 7 Bankruptcy Case is illustrated in FIG. 4. The bankruptcy court then transmits a copy of the notice 302 to every entity named as a creditor in the bankruptcy filing. Filings and notices subsequent to the initial petition are also transmitted to creditors named in the petition, or subsequently. In this case, if the Issuer is named as a creditor, the notice will be sent to the Issuer Location 20. Once the Issuer receives the notice 304, the notice is then immediately forwarded 306 to the Processing Location 30 by the Issuer Location's mail processing facility 22. It is also possible that the Issuer can register a standing request with the court in question that all notices which name the Issuer as a creditor be forwarded directly to the Processing Location 30.

The bankruptcy notice is then received 308 by the Processing Location's mail processing facility 32 where it is readied for input into the system. The mail processing facility 32 can receive bankruptcy notices, either from the court or from the Issuer, in traditional paper format or as an electronic data file.

If the notice is received as an electronic data file, it is formatted in a standardized way known to both the court and the notice processor. One such standard format, and the format used in the preferred embodiment of the present invention, is the Electronic Data Interchange (“EDI”) format. In the preferred embodiment, a notice received in electronic format is first parsed into fields in a temporary database table 316 and then individual fields from the temporary table are mapped to their corresponding fields in the applicable LU (i.e., Case, Attorney, Court, and Trustee LUs) 318. The information in the temporary table is then checked for matches against records in the Bankruptcy, Case, Attorney, Court, Trustee, Issuer and Processed Account LUs 320. If a record matches, this means that the information is already in the Processing Location's database LUs and is discarded 321. If a record does not match, it means it is new information and the data is written to the appropriate LU 322.

If the notice is received as a paper document, the data it contains must be extracted and fixed in digital format for inputting into the appropriate database LUs. This can be accomplished by having a data-entry operator manually key in the data into a database front-end application or by using an automated scanning application which can be programmed to learn the location of relevant data on the notice and use optical character recognition (“OCR”) techniques to automate the data entry.

Because the forms used by bankruptcy courts for transmitting notices are not always uniform, and because the quality of the text in the notices is not always suitable for OCR operations, the preferred embodiment of the present invention utilizes a semi-automated method of data entry for paper forms. The semi-automated method is initiated by processing the paper notice with an optical computer scanner to create a computer-based graphical image of the notice 310. The graphical image is then transmitted through a computer network to a custom data-entry computer application 311.

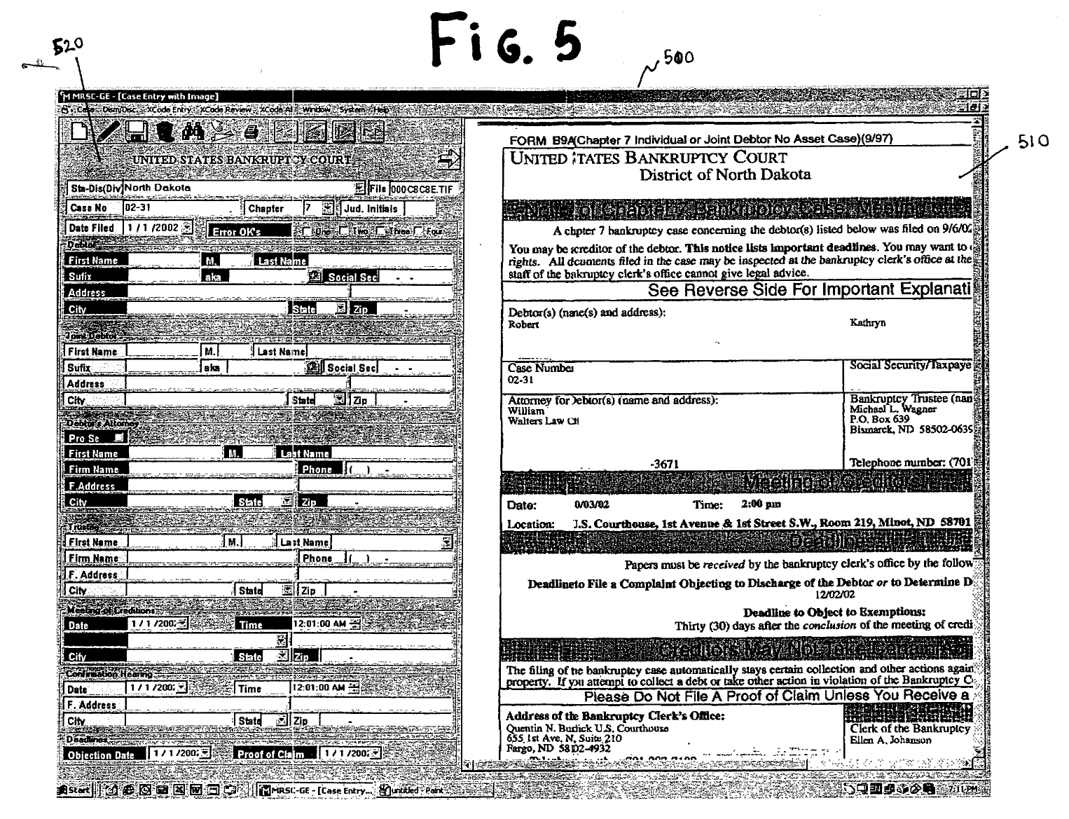

The custom data-entry application, illustrated in FIG. 5, presents a human operator with a split screen on a computer monitor 500. One side of the screen displays the image of the paper notice to be processed 510 and the other side of the screen displays fields for the entry of specific information to be extracted from the image by the human operator 520. As the operator keys in information 312 into the data-entry side of the screen 520, the information is temporarily saved by the data entry application. As with electronically formatted notices, the temporarily saved data is compared for matches against records in the Bankruptcy, Case, Attorney, Court, Trustee, Issuer and Processed Account LUs and only unmatched records are permanently written to the appropriate LUs 322.

Continuing with FIG. 3B, every time a new records is written into the Case LU 200, signifying that a new bankruptcy-related notice has been received and entered, a monitoring mechanism of the database application of the present invention generates a “trigger” event 324. The “trigger”, in turn, generates a process request 326 which references the new record written to the Case LU 200. A process request can be a record which is written to the applicable Issuer LU 260. The process request can be immediately made available for handling or can be queued if the system is occupied with a previously issued process request 328. If a process request is queued, the queue may consist of a queued series of similar records inside the Issuer LU 260.

The most recently issued process request, or the next process request in the process request queue, is routed to a “Bankruptcy Coding Software Object” (“BCSO”) application which in turn executes the process request 330. The BCSO initially looks up the Entity information for the Case record referenced by the process request. That is, the BCSO looks up the bankruptcy notice record in the Case LU 200 and then determines, from the bankruptcy record, the corresponding record in the Entity LU 210. BCSO then constructs an Entity SO 331 from data fetched from the Entity LU 210. This Entity SO will be compared against entities in the subject Issuer's credit card account database 24 for possible matches and if one is found the credit card account database 24 will be updated with information from the bankruptcy notice being processed.

After generating the Entity SO, the BCSO establishes a communications link with the credit card account database 24 and begins searching for matches 332. BCSO conducts its search using the database rules contained in the record of the Rules LU 250 applicable to the credit card account database 24. As a preliminary step 333, the BCSO attempts to eliminate from contention as many records as possible from the credit card account database 24 since it generally contains a massive amount of records which would otherwise take a long time to completely check out individually. This step is usually carried out by building a result set of records obtained by querying the credit card account database 24 several times. Each query retrieving a subset of records singled out by using a number of criterion including but not limited to Social Security Number, Federal Employment ID Number, Last Name+First Name, and the like.

Continuing with FIG. 3C, at step 334, the BCSO generates a Match Candidate SO from the first record returned by the preliminary query for comparison with the Entity SO generated from the Entity LU 210 in step 331. The Match Candidate SO's structure is, in essence, identical to the structure of the Entity SO, but is populated with data extracted from the credit card account database 24 instead of data from the various LUs.

The Match Candidate SO and the Entity SO are compared 335 and if they do not match, the scripting object then generates 334 a new Match Candidate SO from the next record returned by the preliminary search and again compares the Match Candidate SO to the Entity SO 335. There may be multiple accounts returned by the preliminary search that contain Match Candidate SOs that truly match the Entity SO. Thus, all Holder information from all account records in the preliminary result set are compared against the Entity SO.

Whenever a Match Candidate SO and the Entity SO are matched, the BCSO annotates the database record in the credit card account database 24 which corresponds to the Match Candidate SO 338. The annotation consists of revising, if appropriate, the field in the credit card account database 24 which denotes the bankruptcy status of the Holder of the account and of writing any additional information about the bankruptcy notice which is specified in the Rules LU 250 entry for the database in question. Anytime a record in the credit card account database 24 is annotated, the BCSO also generates an entry in the associated Issuer's Processed Account LU 270.

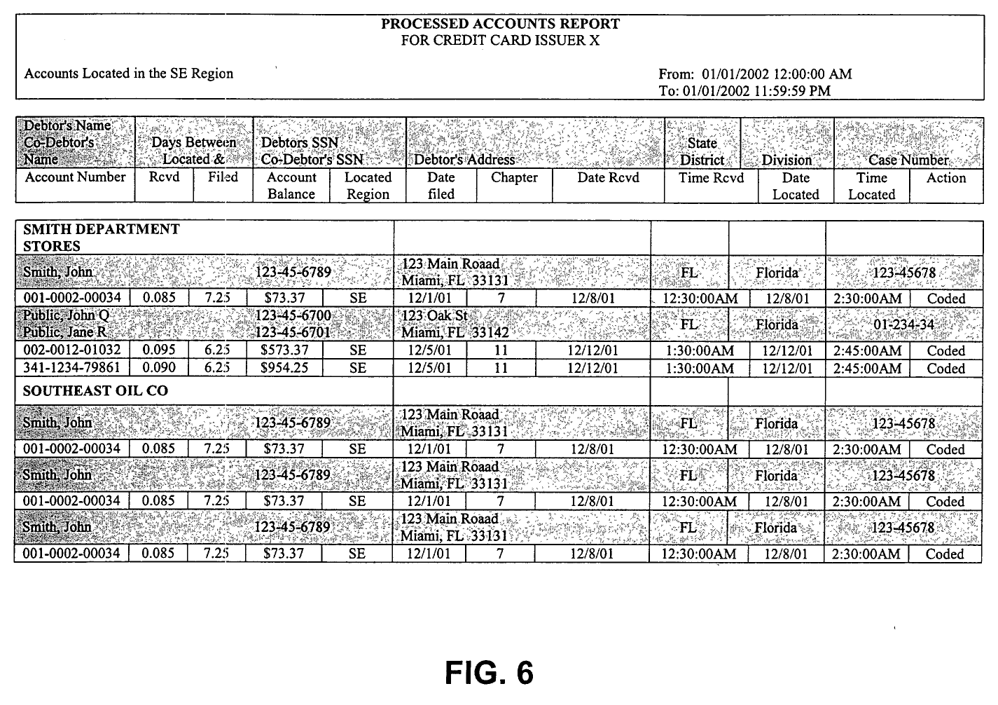

The Processed Account LU 270 is used, as a final step, to generate an activity report of all records annotated using the method of the present invention 340. A sample activity report is illustrated in FIG. 6.

Finally, if the BCSO fails to generate a single match to the Entity SO from the successively generated Match Candidate SOs, a record written to yet another LU entitled Unable To Locate, or UTL, LU 342. Reports from the UTL LU are periodically generated for manual verification since they represent bankruptcy notices filed by an entity in which the Issuer is listed as a creditor but for which the Issuer has no record of an account with the entity.

As can be seen in this specification, at several points in the preferred embodiment of the present invention, data extracted from bankruptcy-related notices is tested for “matches” to data residing in the various LUs. Similarly, Entity SOs are tested for “matches” to Match Candidate SOs. It is important to point out that the determination of whether a “match” has occurred is of critical importance to the accuracy of the method of the present invention and therefore particular care must be exercised in the design of the logic for various matching mechanisms which can be utilized and which are well known to those skilled in the relevant art.

The preferred embodiment of the present invention utilizes a two-tier matching logic. Generally speaking, the present method compares two database “records”, each containing multiple “fields” of data. The first tier of the matching logic, utilizes a set of rules referred to as “Matching Rules”. Matching Rules function at the field-comparison level. Matching Rules define what level of similarity between corresponding fields of the two records being compared is considered to be a match. For example, when comparing an Entity SO with a Match Candidate SO, each of the two SOs may have a field which corresponds to a person's name. The Matching Rules determine how closely the names in each SO must be to each other before the two fields are considered a match.

Matching Rules may consist of one or more tests applied to the two data fields in question as well as a predetermined minimum threshold of similarity beyond which a match is presumed. As an illustration, one of the data fields may contain the string “John Q. Public” while the second filed may contain the string “John Q Public”. If a “character-for-character” test is applied to the two fields, it will reveal that the two fields are not a 100% identical because the first field contains a period after the middle initial while the second doesn't. However, it is obvious to the human eye that the two fields should be considered a match. In order to accomplish this, a similarity threshold may be utilized to, for instance, dictate that a mach of 80% in a “character-for-character” test should be deemed a match.

In order to increase the accuracy of Matching rules, the preferred embodiment of the present invention generally applies a number of tests, in succession, to the candidate fields in order to determine whether a match exists. In addition to a character-for-character test, the Matching rules could utilize, for example: (a) “character count” tests which account for transposed characters (i.e., “John” vs. “Jhon”); or (b) “slide tests” which account for erroneously repeated characters (i.e. “Smith” v. “Smiith”). Each type of test may have its own threshold and the results of the multiple tests may be combined into an average score to increase the confidence level of the result.

Matching Rules, in general, are encoded into the scripting objects which perform the data comparisons as system wide norms which apply regardless of the type of record being compared. However, different Matching Rules may be applied to different types of data. For example, alphanumeric, numeric and date type fields may each have their own set of Matching Rules.

The second tier of the matching logic, utilizes a set of rules referred to as “Comparison Rules”. Comparison Rules operate at the record-comparison level. That is, after Matching Rules have been applied to compare all of the fields in the two records being compared, the Comparison Rules determine what level of similarity overall in the fields is sufficient to establish a match between the records.

For example, the Comparison Rules for a particular Issuer may dictate that in order to deem two records matched, they must have at least one field match exactly and two fields must match partially. For instance, a Comparison Rule may require that in order for an Entity SO to be deemed matched to a Matched Candidate SO, the two SOs must have an exact match in the Social Security Number filed and at least partial matches in the Address and Name fields.

Comparison Rules are generally determined in conjunction with consultations made with the different Issuers whose credit card databases are revised using the present methods. A particular Issuer may follow a more conservative approach to matching and may wish to only consider matches to occur at higher threshold levels (i.e., in the extreme case, only deem that a match has occurred between records when all fields match exactly). Another Issuer may wish to follow a more relaxed matching standard and only require partial matches to establish a match between two records.

In order to allow flexibility between Comparison Rules for different Issuers, the preferred embodiment of the present invention stores Comparison Rules inside the Rules LU 250 applicable to each Issuer.

Accordingly, it will be understood that the preferred embodiment of the present invention has been disclosed by way of example and that other modifications and alterations may occur to those skilled in the art without departing from the scope and spirit of the appended claims.

What is claimed is:

1. A computer-implemented method for automatic remote coding of a debtor credit database with bankruptcy filing information comprising:
a. at a local data processing location, the step of collecting bankruptcy filing reports from courts located within the various jurisdictions for which the method provides coverage;
b. at said local data processing location, the step of extracting unique debtor identifying data from said bankruptcy filing reports;
c. at said local data processing location, the step of generating a database query designed to identify database records which match said unique debtor identifying data;
d. the step of establishing an electronic connection between said local data processing location and a remote credit database storage location, said electronic connection being suitable for two-way transmission of data between said local data processing location and said remote credit database storage location;
e. the step of executing, from said local data processing location, said database query against a debtor credit database housed at said remote credit database storage location and identifying debtor records matching said database query; and
f. the step of, coding said matching records at said debtor credit database with bankruptcy filing information.
